(19) United States
(12) Patent Application Publication
(10) Pub. No.: US 2013/0036925 A1
(43) Pub. Date: Feb. 14, 2013

(54) OFFSET IMAGING SYSTEM

(71) Applicant: Moshe Nakash, Ramat Hashron (IL)

(72) Inventor: Moshe Nakash, Ramat Hashron (IL)

(21) Appl. No.: 13/205,718

(22) Filed: Aug. 9, 2011

(51) Int. Cl. B41F 7/02

(52) U.S. Cl. 101/217

(57) ABSTRACT

An imaging apparatus (10) forms an image on an offset media (100) including a carriage (220), which moves relative to the offset media wherein the offset media includes a top and bottom layer. A first imaging unit (208) mounted on the carriage and configured to image at high intensity the non-image areas of the offset media. A second imaging unit (212) mounted on the carriage configured to image at lower intensity than the first imaging unit wherein the second imaging unit is configured to image the image of the offset media. A data feeder (232) configured to supply non-image data to the first imaging unit and image data to the second imaging unit. A controller (216) configured to provide imaging data to the data feeder. Image areas on top layer are fixated by the second imaging unit. Non-image areas are ablated from the top layer by the first imaging unit.

### CROSS REFERENCE TO RELATED APPLICATIONS

Reference is made to commonly-assigned copending U.S. patent application Ser. No. 13/100,428, filed May 4, 2011, entitled METHOD FOR OFFSET IMAGING, by Matzner et al.; and U.S. patent application Ser. No. ______ (Attorney Docket No. K000527US01NAB), filed herewith, entitled METHOD FOR OFFSET MEDIA SYSTEM, by Nakash; the disclosures of which are incorporated herein.

### FIELD OF THE INVENTION

This present invention relates to an imaging system for a computer-to-plate (CTP) printing system and more specifically to a processless system which includes a dedicated imaging head in conjunction with an offset printing plate.

### BACKGROUND OF THE INVENTION

Most of the known processes of making offset printing plates require the use of chemicals to dissolve the non-image area of the plate. Other processes such as pre-wash, pre-heat, gumming, and post-baking may also be used. These processes are costly and may not be environmentally friendly.

Normal plates are divided into two categories, negative plates, where the exposure is done in the image area causing the coating in the image to be stronger, and positive plates in which the exposure to the laser is done on the non-image area that is weakened by the energy.

In negative plates normally a stronger and more robust image is achieved due to chemical cross linking, and the weak non-image area is dissolved by a developer and washed off. In positive plates the image is generally less robust but after exposure, the non-image is weaker and can selectively be dissolved and removed by a developer. Both positive and negative plates are gummed after the exposure of the aluminum substrate background.

### SUMMARY OF THE INVENTION

Briefly, according to one aspect of the present invention an imaging apparatus for forming an image on an offset media includes a carriage, which moves relative to the offset media. The offset media further includes a top layer and a bottom layer. A first imaging head is mounted on the carriage for imaging non-image areas on the surface of the offset media by using high intensity power. A second imaging mounted on the carriage for imaging image areas on the surface of the offset media by using a lower intensity than the intensity used by the first imaging unit.

A data feeder supplies non-image data to the first imaging unit and image data to the second imaging unit. A controller provides imaging data to the data feeder. Image areas on top layer are fixated by the second imaging unit and non-image areas are ablated from the top layer by the first imaging unit.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

FIG. 1 is a schematic representation of a plate consisting of hydrophilic and hydrophobic layers;

FIG. 2 is a schematic representation of a plate imaging device; and

FIG. 3 is a schematic representation of printing sleeves mounted on a printing cylinder.

### DETAILED DESCRIPTION OF THE INVENTION

In the following detailed description, numerous specific details are set forth in order to provide a thorough understanding of the disclosure. However, it will be understood by those skilled in the art that the teachings of the present disclosure may be practiced without these specific details. In other instances, well-known methods, procedures, components and circuits have not been described in detail so as not to obscure the teachings of the present disclosure.

While the present invention is described in connection with one of the embodiments, it will be understood that it is not intended to limit the invention to this embodiment. On the contrary, it is intended to cover alternatives, modifications, and equivalents as covered by the appended claims.

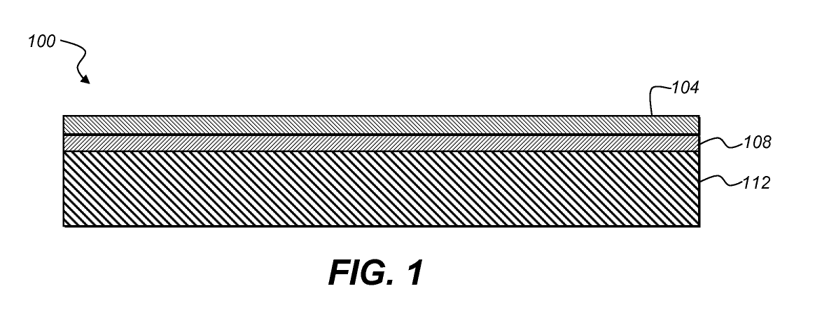

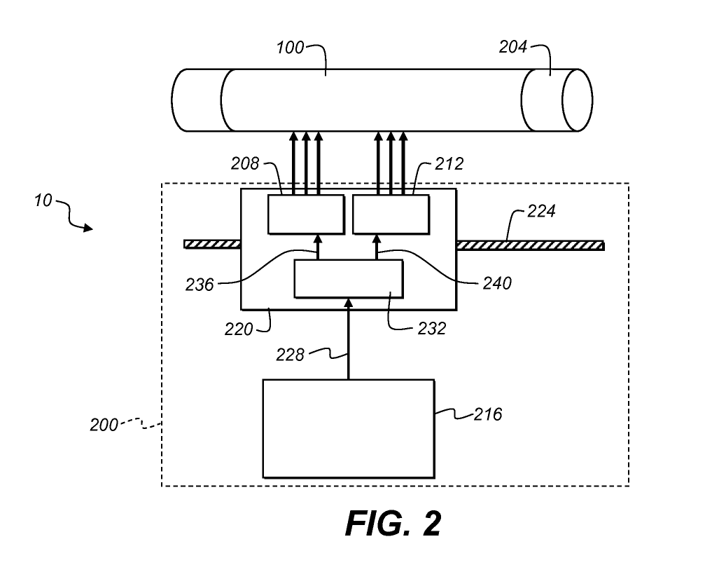

The plate imaging system 10, shown in FIG. 2 provides a processless solution for making offset printing plates or sleeves. The system includes two main components. The first component is an offset plate 100, shown in FIG. 1. Offset plate 100 is either a negative nor a positive plate. Offset plate 100 is configured for exposure by laser means over the entire offset plate 100 surface.

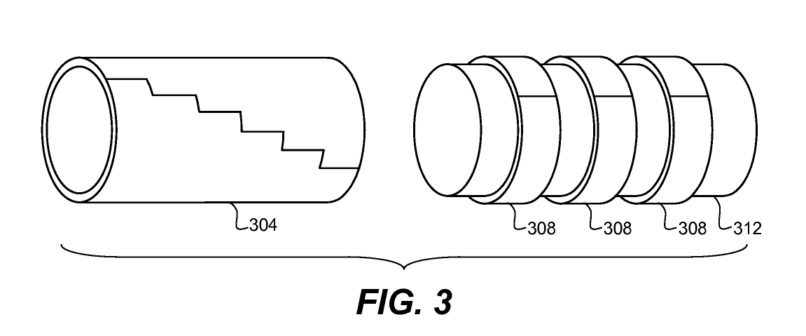

Offset plate 100 is based on a two layer construction, a bottom hydrophilic layer 108 and a top hydrophobic layer 104. The hydrophilic layer allows the elimination of the gumming step. The two layers 104 and 108 are positioned on a support layer 112. Similarly a printing sleeves 304 (FIG. 3) having a bottom hydrophilic layer 108 and a top hydrophobic layer 104 can be employed according to the invention. FIG. 3 shows a continuous sleeve 304 mounted on a cylinder 312 and several separated sleeve sections 308 mounted on a cylinder.

FIG. 2 shows an imaging device 200. The imaging device 200 includes an imaging carriage 220 on which a laser imaging unit 208 and laser imaging unit 212 are mounted. Imaging unit 208 is set to apply radiation at an intensity higher than imaging unit 212. The laser imaging units 208 and 212 are configured to image on offset plate 100, which is mounted on a rotating drum 204. The carriage 220 is adapted to move substantially parallel to drum 204 guided by an advancement screw 224.

Offset plate 100 is exposed by laser imaging units 208 and 212. Laser imaging unit 208 is configured to ablate the hydrophobic layer 104. The ablated parts of hydrophobic layer 104 represent non-image areas on offset plate 100. The non-imaged areas are represented by the image data 236 provided to the laser imaging unit 208 by data feeder 232. The data feeder 232 receives imaging data 228 from controller 216 and sends the non-image data 236 to imaging unit 208 and the image data 240 to imaging unit 212. The ablation of hydrophobic layer 104 is achieved by operating laser imaging unit 208 at high power. The laser imaging unit 208 is set to operate at high power. The increased power applied by imaging unit 208 on the non-image areas ablates the hydrophobic layer 104. Imaging unit 212 images the image data 240, imaging unit 212 is set to operate at a lower power intensity than imaging unit 208. The reduced power applied by imaging unit 212 will cause strengthening of the image by cross linking the coating and by imparting adhesion between the plate layers 104 and 108.

The non-imaging parts of the plate are imaged by utilizing the higher laser power imaging unit 208, whereas the imaging parts are imaged by the lower intensity imaging unit 212. The non-image data 236 is provided to imaging unit 208 whereas the image data 240 is provided to imaging unit 212 by data feeder 232. This concept provides the benefits of both negative and positive plate technologies. A clean background will be achieved as in positive plates, in addition to the robustness of negative plates.

The imaging of plate 100 can be performed by a single path where each of laser units 208 and 212 operate together. Alternatively the imaging can be performed in two paths, wherein the first path the non-image data is treated by laser unit 208 and the image data is imaged by imaging unit 212 in a following path. The sequence of imaging can be also by starting with imaging unit 212 with data 240 following with an additional path with imaging unit 208 with data 236.

Since the processes on the plate are thermal in nature, the type and rate of the reaction on the plate is determined by the local temperature. At points where layer removal is required, the laser head may deliver high power laser spot which ablates the hydrophobic layer on the plate. At points where the plate active layer should be fixed, the laser head provides lower energy levels, which induces a fixating reaction.

In summary, this system is different from known CTP systems, in that it exposes every part of the plate, partly by ablation of layer 104 to the level of layer 108 (by using higher laser power imaging unit 208) and partly by fixation of layer 104 (by using lower laser power imaging unit 212), depending on the imaging data 228.

The invention has been described in detail with particular reference to certain preferred embodiments thereof, but it will be understood that variations and modifications can be effected within the scope of the invention.

### PARTS LIST

10 plate imaging system
100 offset plate (media)
104 hydrophobic layer
108 hydrophilic layer
112 support layer
200 imaging device
204 drum
208 laser imaging unit
212 laser imaging unit
216 controller
220 carriage
224 screw
228 imaging data
232 data feeder
236 non-image data for laser imaging unit 208
240 image data for laser imaging unit 212
304 printing sleeve
308 sleeve sections
312 cylinder

1. An imaging apparatus for forming an image on an offset media comprising:
a carriage which moves relative to said offset media wherein said offset media further comprises a top layer and a bottom layer;
a first imaging unit mounted on said carriage and configured to image at high intensity a non-image areas of said offset media;
a second imaging unit mounted on said carriage configured to image at lower intensity than said first imaging unit wherein said second imaging unit is configured to image an image area of said offset media;
a data feeder configured to supply non-image data to said first imaging unit and image data to said second imaging unit;
a controller configured to provide imaging data to said data feeder;
wherein image areas on top layer are fixated by said second imaging unit; and
wherein non-image areas are ablated from said top layer by said first imaging unit.

2. The apparatus according to claim 1 wherein said offset media is a sleeve.

3. The apparatus according to claim 1 wherein offset media is an offset plate.

4. The apparatus according to claim 1 wherein said offset media is mounted on a cylindrical drum.

5. The apparatus according to claim 1 wherein the power intensity is adjusted by pulse width modulation.

6. The apparatus according to claim 1 wherein the power intensity is adjusted by pulse duration.

7. The apparatus according to claim 1 wherein the power intensity is adjusted by changing a wavelength of radiation produced by the imaging head.

8. The apparatus according to claim 1 wherein the offset media comprises:
a hydrophobic layer; and
a hydrophilic layer.

9. The apparatus according to claim 8 wherein the non-imaged ablated areas are the hydrophilic layer.

10. The apparatus according to claim 1 wherein said first imaging unit and said second imaging unit image said offset media at the same path.

11. The apparatus according to claim 1 wherein said first imaging unit images said offset media at a first path and said second imaging unit images said offset media at a second path.

12. The apparatus according to claim 1 wherein said second imaging unit images said offset media at a first path and said first imaging unit images said offset media at a second path.
